(19) United States
(12) Patent Application Publication
(10) Pub. No.: US 2010/0241581 A1
(43) Pub. Date: Sep. 23, 2010

(54) System and Method for Interactive Interview and Recruitment

(76) Inventors: Prem Duraiswamy, Tirupur (IN); Aadith Duraiswamy, Tirupur (IN); Yeragaselvan Kumaraswamy, Tirupur (IN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/226,271

(22) PCT Filed: Oct. 17, 2007
(86) PCT No.: PCT/IN07/00484

§ 371 Date: Oct. 14, 2008

(30) Foreign Application Priority Data
Jun. 26, 2007 (IN) 1364/CHE/2007

(51) Int. Cl. G06Q 10/00; G06F 17/30

(52) U.S. Cl. 705/321; 707/803; 707/E17.005

(57) ABSTRACT

The invention relates to a system and method for interactive interview and recruitment which comprises of plurality of interactive application means for collecting recruiters of hiring needs of first type seeking video interview assistance and of second type seeking automatch assistance; plurality of interactive application means for collecting resume of prospective applicants of first type seeking video interview assistance and of second type seeking automatch assistance; plurality of interlace application means for automatching the resume of second type and forwarding the same along with resume of first type to recruiters of first type, and the interface application means further automatching the resume of second type and forwarding the same to recruiters of second type; and plurality of interactive application means for enabling video communications between the interfaced first type applicants and the first type recruiters.

### INTRODUCTION

A system and method that provides an interactive voice/video-based recruitment solution is disclosed. The system enables an employer to search and screen resumes of jobseekers, post scheduled interviews for a job profile or instantly invite preferred candidates and conduct online voice/video-based interviews. LVIS offers the employers/recruiters option to save a live interview for future references. The advantage of this system is that the location of the employers and the job seekers need not be a limitation.

### FIELD OF THE INVENTION

The present invention relates to a method and a system for providing an interactive voice/video-based recruitment solution. More specifically, the present invention relates to a method with a system which enables an employer to use a computer network such as Internet, to screen resumes and conduct online voice/video-based interviews, and enables jobseekers to apply for the job positions and participate in interviews.

### BACKGROUND OF THE INVENTION

The time and cost factor that incurs to the company for a customary recruitment process to employ a successful candidate with the desired skill set is very high. This creates a backlog of tasks in projects driven by time and cost. The proposed LVIS system helps in overcoming the difficulties of the traditional system by cutting down these factors to a great extent. The recruitment process is made much faster with minimal cost. From the job seeker standpoint the deciding factors to accept a job offer is made easier, and simpler at no extra cost.

### SUMMARY OF THE INVENTION

So it is therefore an object of the invention to provide an interactive voice/video-based recruitment solution. LVIS includes but is not limited to a first set of database with job seeker resume and second set of employer's database. The system provides job related information obtained from the employer database to the job seeker and selected information is targeted specifically to select set of job seeker as classified in the job seekers database. The system further provides job seekers related information obtained from the job seekers database to the employers and selected information is targeted specifically to select set of employers as classified in the employer's database.

All the above activities are deployed in a website and made accessible to the job seeker and employers online.

LVIS also further provides interaction between the job seeker and the employers online, the interaction firstly comprises the job seekers seeking employer for an interview or alternatively the employer seeking the job seekers for an interview, secondly identifying and establishing a contact between themselves for an interview, and thirdly employer conducting an interview with the selected job seekers via the internet more specifically, an online interview which may be a voice based interview, a video based interview or a combination of the two.

The employer can interact with the job seeker by the following means once they have access to the job seeker resume: E-mail, SMS, Web Triggered Telephonic Call, Audio Conference, and Video Conference.

It is an additional object of the system to provide a new business method by which the customers are required to buy the credits in advance and use it only for what is required. For an employer to search for job seeker's profile matching his job requirement, the system doesn't charge any credit. All the job seeker profile's matching the employer's search criteria are displayed including/excluding the contact details and full resume. The other services offered such as Web triggered telephonic call, Audio conference, Video conference are charged based on service time.

The presented invention also provides a method to save a live interview for future references.

The presented invention facilitates a job seeker to virtually participate in an interview therefore opening endless opportunities. The Job seeker can also present a resume with photo, audio and video introduction.

A system and method that provides an interactive voice/video-based recruitment solution is disclosed. The system enables an employer to search and screen resumes of jobseekers, post scheduled interviews for a job profile or instantly invite preferred job seekers and conduct online voice/video-based interviews. The system facilitates auto matching of job seeker profiles with the posted job or interview and mails it to the employer's inbox, in addition to the applications from job seekers. Each employer registered with the system is provided a login which acts as the administrator having all privileges. In addition, optional recruiter logins are supplied which are grouped under the respective employer. The term employers and recruiters are used interchangeably across this document. Apart from already registered job seekers the employer can invite candidates from his company and conduct online audio/video interviews with their client making use of the services offered by LVIS system. The employers can purchase credits and it will be deducted against the services used. The system enables a job seeker or candidate to upload resumes, search and screen job/interview postings, apply for job/interview, participate in online voice/video-based interviews, maintain friends list, refer friends for suitable jobs/interviews, subscribe for newsletter/alerts, and manage profile and resumes. The job seeker can use the email, SMS and web triggered telephonic call facility to alert a friend.

### DESCRIPTION OF THE INVENTION

A system and method comprising Audio and Video capture device on the client side, web application server, streaming server, LVIS interface, employers database, job seekers database, user's account, login and the system management facility provides a recruitment solution for the employer and job seeker.

FIG. 1 shows the application of “LVIS” system to WHEREISMYBOSS.COM a job portal. The functionalities offered differ according to the type of user signing in as an employer or a job seeker. The set of services that is provided to an employer includes posting interviews/jobs, conducting scheduled and instant audio/video interviews, save the conducted interviews for future reference in addition to other recruitment services that are offered. The online status of the job seeker is displayed to the employer. The employer can add preferred candidates to his list. The employer is further provided with additional features as follows as:

1) Candidate manager for comparison of candidates enabling easy screening and shortlisting.
2) Reschedule Service for changing the interview timings for interview postings and privately scheduled interviews.
3) Remainder Service to shortlisted candidates for interviews. The employer may remind the shortlisted candidates by way of SMS or Email of the interview date and time.
4) Introducing Levels of interviews, the process of liveconnect video interview session can be continued further. The interviewer can conduct the first level of interview and forward his review and comments along with interview history to his seniors. Levels of interview offers an employer the following opportunities to complete his recruitment process and hire the candidate using LVIS which are:
a) If the candidate pass through the initial interview, his/her profile can be forwarded for next level of interview to another recruiter with review/comments on their performance.
b) The forwarded recruiter has to schedule an interview time with the candidate for next level.
c) The candidate will be informed that he/she has been selected in first level and will be rescheduled to next level of interview.
d) The definite levels of interviews that can happen within an employers organization is defined by the employer in his Account Settings.
e) The employer after the first level of interview may wish to hire the candidate immediately or call for a personal interview which in case levels are not applicable.

The job seeker can apply for the posted interviews and participate in the audio/video recruitment process. If a job seeker is in an interested list of an employer, the count and list of employers is displayed to the job seeker as being on the interested list of an employer so that the job seeker can have the option to stay online and attend instant interview if the employer prefers. The statistics of the applied, selected, awaiting and rejected numbers for the jobs/interviews applied are displayed to the job seeker. The job seeker is further provided with additional features which are as follows as:
1) Maintain Favorite Employer List, the job seeker can track all the openings available.
2) Job seeker can mail personalized video profiles to employers (saying why he/she feels qualified to work in that specific org)
3) Making employers know the online availability status of job seekers.

FIG. 2 shows the brief system architecture for the LVIS system. The end user connects to the LVIS server to access the services offered. The LVIS server comprises of the database server having the employer's database containing jobs/interview postings and job seekers database, web server, application server and streaming server. The streamed data from the user is transferred to the streaming server from where it is broadcasted to other users connected to this interview session.

FIG. 10 and FIG. 11 shows the Recruitment process of LVIS System. FIG. 10 shows a sample LVIS screen of the video interview session of “One Recruiter interviewing a single job seeker” and FIG. 11 shows a sample LVIS screen of the video Interview Session of “Multiple Recruiters interviewing a single job seeker”.

### BRIEF DESCRIPTION OF THE DRAWINGS

FIG. 1 Application of Live Video Based Interview System to WHEREISMYBOSS.COM a job Portal—A functional diagram of WHEREISMYBOSS.COM

FIG. 2 Live Video Based Interview System Architecture

FIG. 3 Interview Model—One to one interaction between a recruiter and a job seeker

FIG. 4 Interview Model—Multiple recruiters interviewing a single job seeker

FIG. 5 Interview Model—One recruiter interacting with multiple job seekers

FIG. 6 Interview Model—Multiple recruiter interacting with multiple job seeker

FIG. 7 Interview Type—Instant interviews

FIG. 8 Interview Type—Scheduled interviews

FIG. 9 Interview Type—Virtual Job Fairs

FIG. 10 LVIS Video Interview Session, One Recruiter interviewing a single job seeker

FIG. 11 LVIS Video Interview Session, One Recruiter interviewing a multiple job seeker

FIG. 12 LVIS Video Interview Session, Multiple Recruiter interviewing a single job seeker.

FIG. 13 LVIS Video Interview Session, Multiple Recruiters interviewing a multiple job seeker

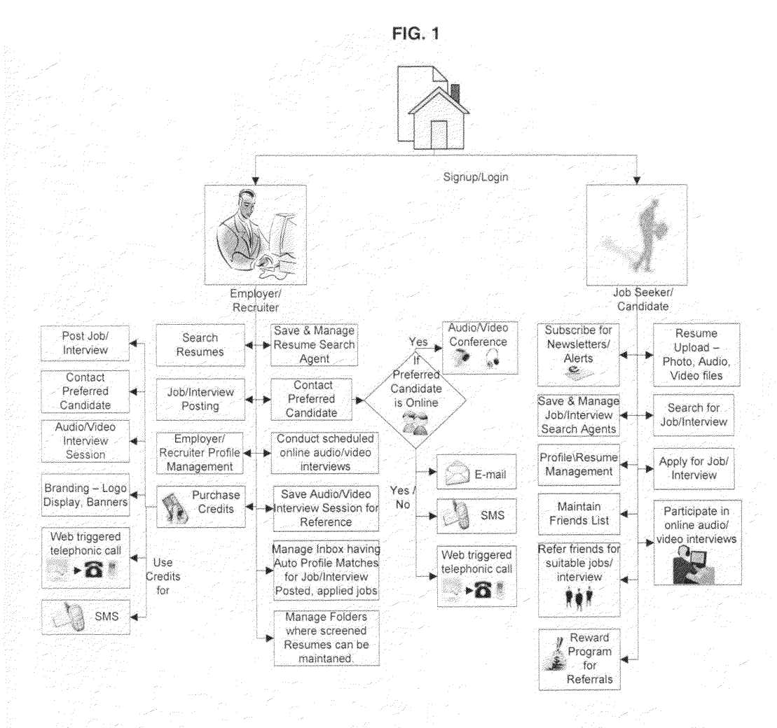

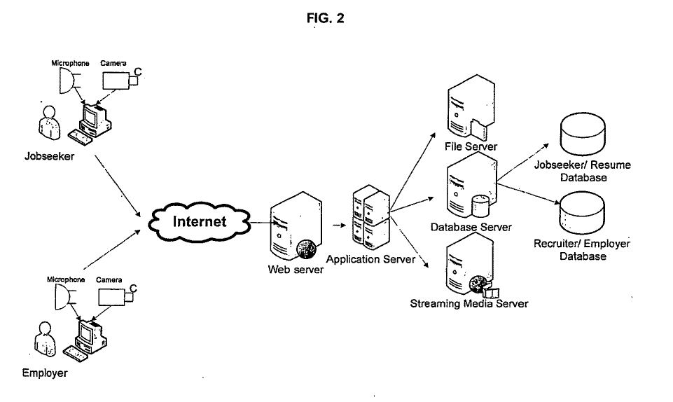

### DETAILED DESCRIPTION OF INVENTION WITH REFERENCE TO DRAWINGS

In the present invention, a system and method for an interactive video based interview which provides a recruitment solution for the employer and job seeker is explained in detail. This Live Video Based Interview offers the following methods and means for an employer and job seeker to interact effectively and each method is explained with the flowchart.
1. Instant interviews
2. Scheduled interviews
3. Virtual Job Fairs

A method and system for managing recruitment related activities preferably all activities being on-line more specifically a job interview through a system containing the functionalities that includes but is not limited to a first set of database with candidate resume and second set of employers database. The system provides job related information obtained from the employer database to the candidates and selected information is targeted specifically to select set of candidates as classified in the candidates database. The system further provides candidates related information obtained from the candidates database to the employers and selected information is targeted specifically to select set of employers as classified in the employers database.

All the above activities are deployed in a website and made accessible to the candidates and employers online.

The system also further provides interaction between the candidates and the employers online, the interaction firstly comprises the candidates seeking employer for an interview or alternatively the employer seeking the candidates for an interview, secondly identifying and establishing a contact between themselves for an interview, and thirdly employer conducting an interview with the selected candidates via the internet more specifically, an online interview which may be a voice based interview, a video based interview or a combination of the two.

The system involves gathering of information of various employers seeking job seeker and various job seeker seeking jobs. The information is primarily classified into employer and job seeker category. Further it may be classified into types of employer's needs and job seeker qualifications. The system is adapted to associate the employer's need with job seeker qualification, based on a set of criteria developed as per the invention.

The employers and job seeker information are in the databases and shall include the information particulars and in the format as demanded for the working of the invention.

The method will handle identifying the job seeker' qualification information in job seeker database and match those with those information relating to opportunities of job with the said qualification from the employer database, to select the appropriate set of job seeker as suggested job seeker to an employer.

The method will further handle identifying potential employers and present the information to the job seeker. The selection criteria and suggestions made to the employer and employee results in employer identifying the potential job seeker with whom to seek and conduct interview for recruitment and also further includes also in job seeker identifying the potential employers with whom to seek interview for a placement. The storing of information relating to plurality employers and plurality of job seeker, identifying a set of employers and a set of job seeker and conducting interview of job seeker by employers are all online, without any human intervention in manually. The on-line communication may be audio or video type.

### Instant Interviews:—

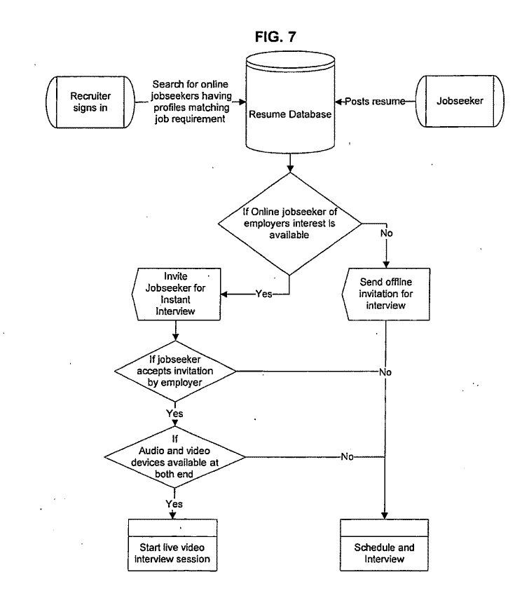

Recruiter signs in and searches for online job seekers (i.e. job seeker who are at present signed in) and requests for an instant interview with preferred members having profiles conforming to their job requirement. FIG. 7 illustrates the block diagram of the method of instant interviews for an employer and job seeker to interact effectively.

### Scheduled Interviews:—

Scheduled Interviews are of two types—Scheduled Interview Posting, Private Individual Scheduling. Scheduled Interview Posting is explained as below. Recruiter posts a scheduled Jobs and/or interview in the job portal and any job seeker matching the job profile can apply for this scheduled interview. Based on the selection criteria, recruiters can accept\deny the application by the job seeker. On approval by the recruiter, a communication link is established for live voice/video based interview. The session is enabled on the interview date and time.

Private Individual Scheduling: Recruiter signs in and searches for job seekers (online or offline) and may schedule an individual interview timing with preferred members having profiles conforming to their job requirement. If the Job seeker accepts the invitation from the employer, a communication link is established for live voice/video based interview. The session is enabled on the interview date and time.

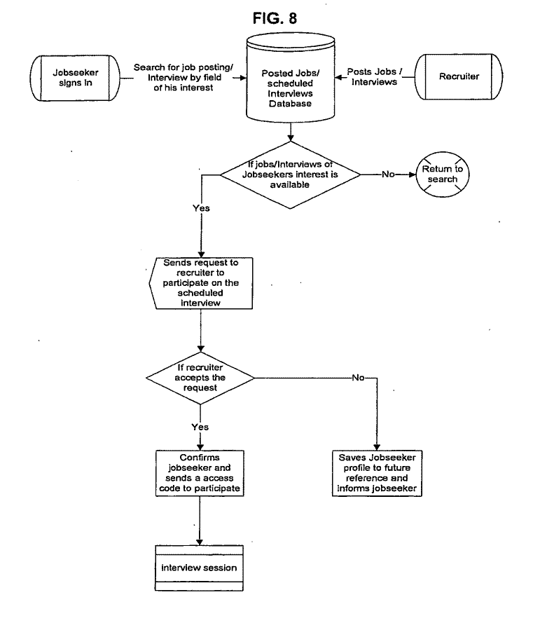

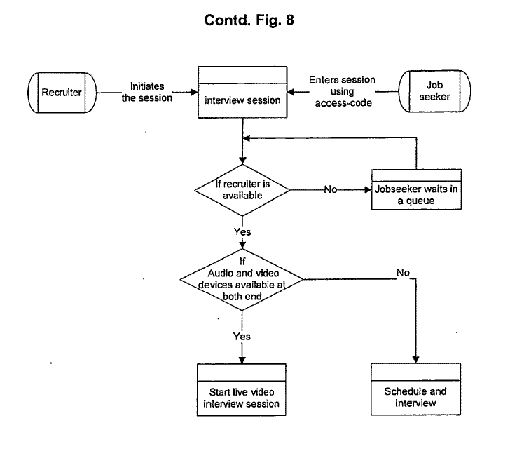

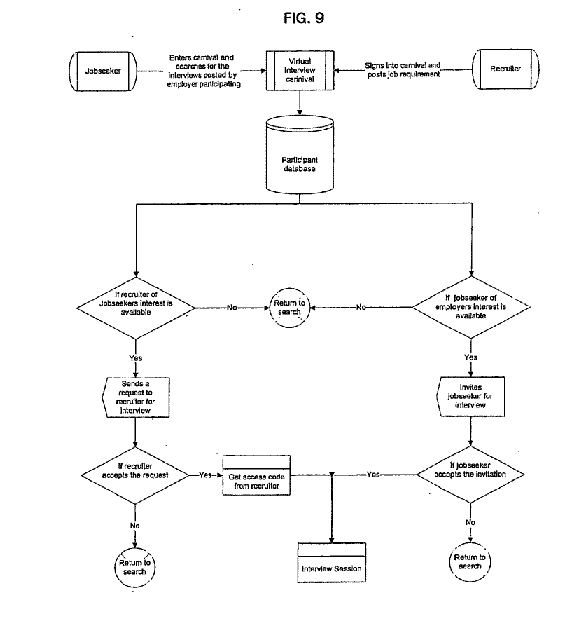

FIG. 8 illustrates the block diagram of the method of scheduled interviews for an employer and job seeker to interact effectively.

### Virtual Job Fairs:—

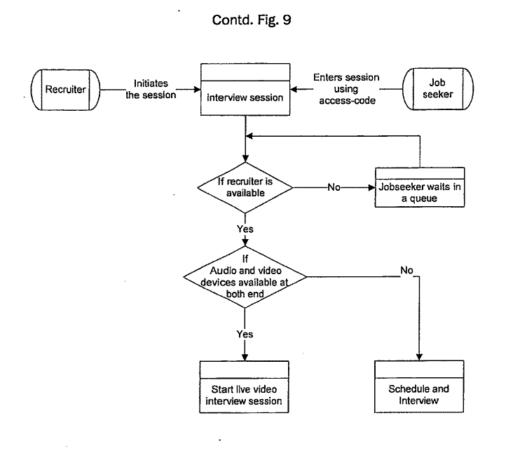

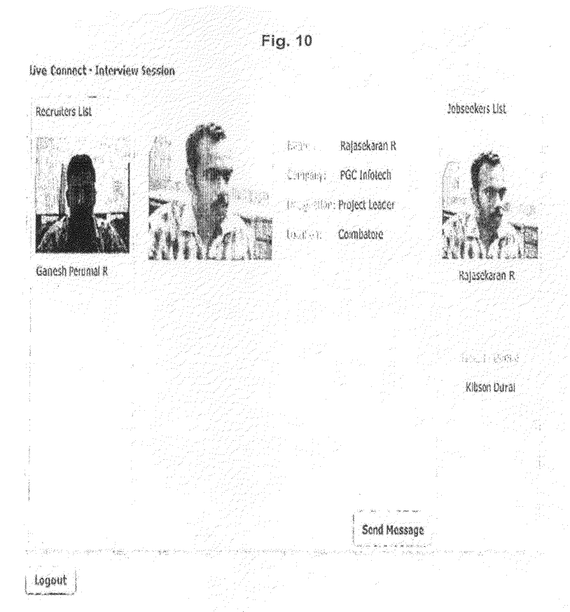

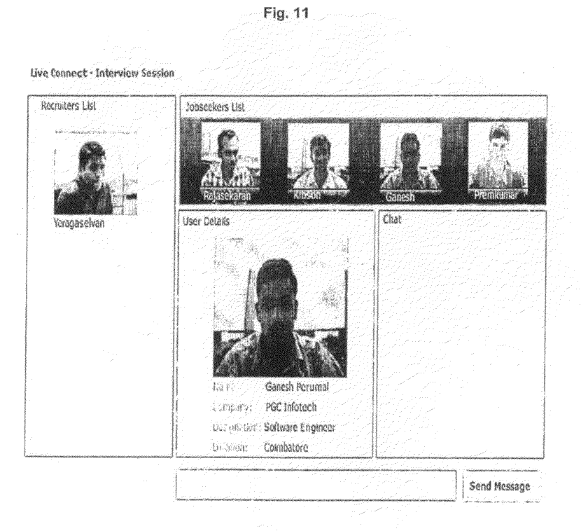

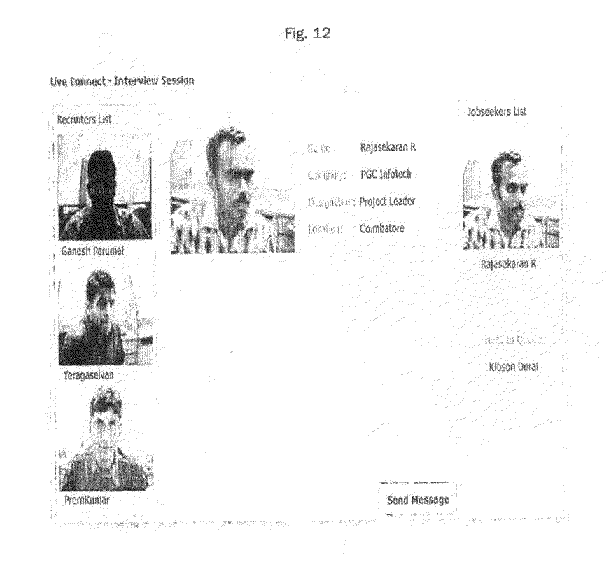

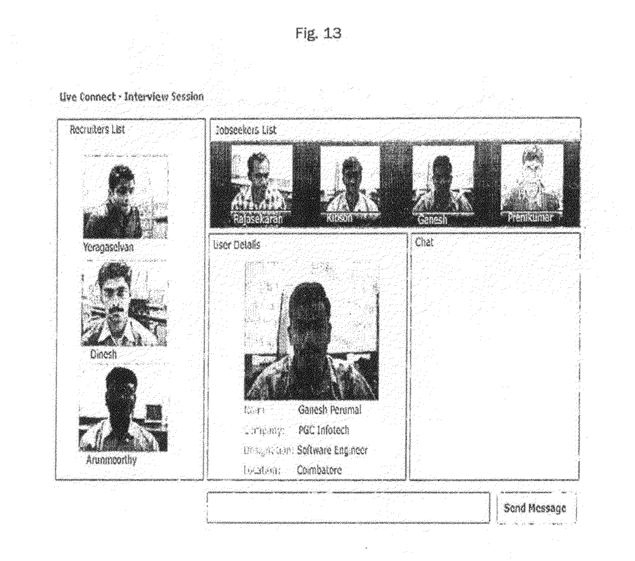

On a scheduled date and time multiple recruiters and job seekers who are online can interact based on their interest. FIG. 9 illustrates the block diagram of the method of Virtual job fairs for an employer and job seeker to interact effectively.

### Models:—

As per the invention, each of the above mentioned methods can be based on the following model which is explained below:—
1. One to one interaction between a recruiter and a job seeker
2. Multiple recruiters interviewing a single job seeker
3. One recruiter interacting with multiple job seekers
4. Multiple recruiter interacting with multiple job seeker

### One to One Interaction Between a Recruiter and a Job Seeker:—

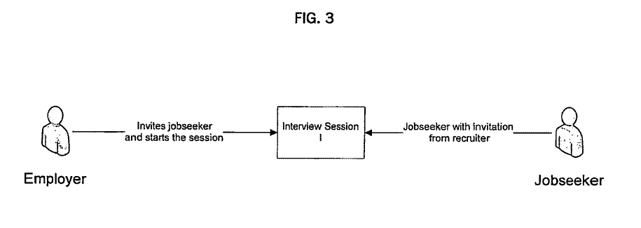

The recruiter may be a single person or a panel of recruiting board members representing the employer can interview a job seeker. This is illustrated in FIG. 3.

### Multiple Recruiters Interviewing a Single Candidate:—

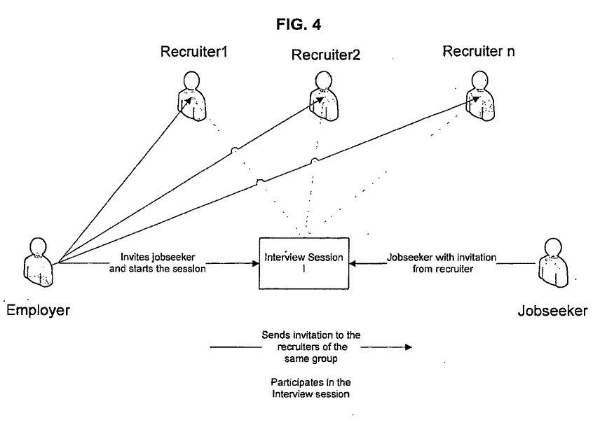

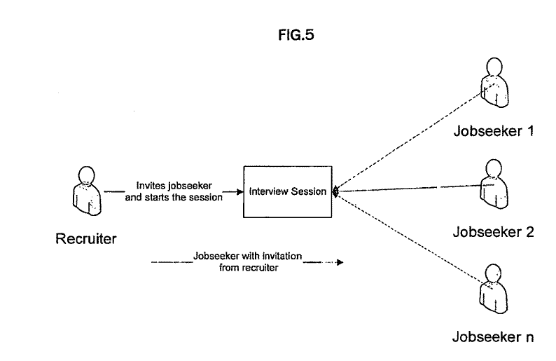

The recruiter may be a single person or a panel of recruiting board members representing multiple employers (i.e. company and its client or a group of company) can interview a job seeker. This is illustrated in FIG. 4.

One Recruiter Interacting with Multiple Job Seekers:—

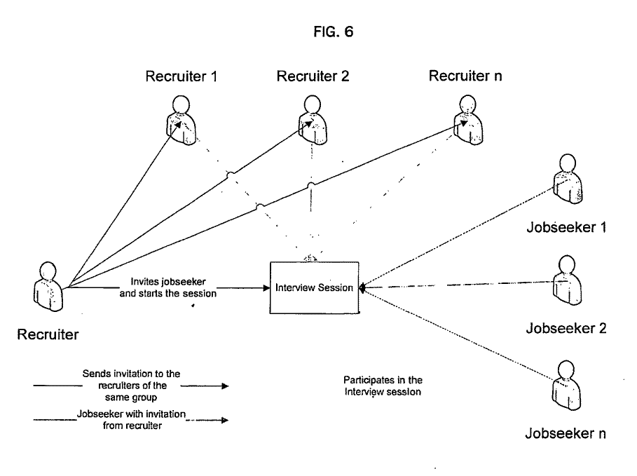

The recruiter may be a single person or a panel of recruiting board members representing the employer can interview any number of job seekers. This may be helpful if the interviewer wants to arrange for a group discussion or a forum based discussion. This is illustrated in FIG. 5.

### Multiple Recruiters Interacting With Multiple Job Seekers:—

The recruiter may be a single person or a panel of recruiting board members representing multiple employers (i.e. company and its client or a group of company) can interview any number of job seekers. This will be helpful if Job fairs are organized.

The invention relating to pooling the information of potential job seeker seeking job, pooling the information of potential employers offering jobs to these potential job seeker and offering the services via website including web postings, which services comprises of selectively offering information of potential job seeker to employers and potential employers to job seeker, thereby enabling establishment of communication between a potential employer and a job seeker for an online interview, which interview may be voice type or video type. This is illustrated in FIG. 6.

We claim:

1. A system and method for interactive interview and recruitment comprising:—
a. plurality of interactive application means for collecting recruiters of hiring needs of first type seeking video interview assistance and of second type seeking automatch assistance;
b. plurality of interactive application means for collecting resume of prospective applicants of first type seeking video interview assistance and of second type seeking automatch assistance;
c. plurality of interface application means for automatching the resume of second type and forwarding the same along with resume of first type to recruiters of first type, and the interface application means further automatching the resume of second type and forwarding the same to recruiters of second type; and
d. plurality of interactive application means for enabling video communications between the interfaced first type applicants and the first type recruiters.

2. A system for interactive interview by identifying and determining the plurality of applicants who applied for the hiring needs of a recruiter and also further determining the plurality of applicants who satisfy the hiring needs of the recruiter, seeking resume of applicants for an interview, with
(i) a service provider node for accessing web;
(ii) an internet site that allows transmitting and receiving documents using a server and a memory;
(iii) a common link between the node and the internet, comprising of:—
a first interactive application means for collecting recruiters hiring needs data as a document and storing the hiring needs data in a first interview match recruiters database in the memory; each of the plurality of hiring need data being respectively associated with one of the plurality of distinct recruiter;
a second interactive application means for collecting job applicant resume data as a document and storing the job applicant data in a second interview match applicant database from the applicant node in the memory server; each of the plurality of applicant data being respectively associated with one of the plurality of distinct applicant;
a third interactive application means for collecting job applicant resume data as a document and storing the job applicant data in a third automatch applicant database from the applicant node in the memory server; each of the plurality of applicant data being respectively associated with one of the plurality of distinct applicant;
a first interface application means for automatically cross referencing the plurality of data in second interview match applicant database to plurality of data in first interview match recruiters database, to identify and determine the plurality of applicants who applied for the hiring needs of a recruiters, including a plurality of recruiters, each having a specific hiring needs;
a second interface application means for automatically cross referencing the plurality of data in third automatch applicant database to plurality of data in first interview match recruiters database, to identify and determine the plurality of applicants who satisfy the hiring needs of a recruiters, including a plurality of recruiters, each having a specific hiring needs;
a first listing application means coupled to first interactive application means, second interactive application means and also first interface application means for determining the prospective applicants associated with the hiring needs,
a second listing application means coupled to first interactive application means, third interactive application means and also second interface application means for determining which of the identified recruiters should be offered with prospective applicants associated with the hiring needs,
a first offer application means coupled to first listing application means for offering the prospective associated applicants to the identified recruiters;
a second offer application means coupled to second listing application means for offering the prospective applicants to the identified recruiters;
an application means for enabling video interviewing initiated by the identified recruiter, with any one, some or all of offered prospective applicants to the identified recruiter;
an application means for the recruiter to enable invoking a process for accepting none, one, some or all of the interviewed applicants; and
an application means for the recruiter to enable invoking a process for request closure after the interviewed applicants accept the offer of the recruiter.

3. A system for interactive interview by identifying and determining the plurality of applicants who applied for the hiring needs of a recruiter seeking resume of applicants for an interview, with
(i) a service provider node for accessing web;
(ii) an internet site that allows transmitting and receiving documents using a server and a memory;
(iii) a common link between the node and the internet, comprising of:—
a first interactive application means for collecting recruiters hiring needs data as a document and storing the hiring needs data in a first interview match recruiters database in the memory; each of the plurality of hiring need data being respectively associated with one of the plurality of distinct recruiter;
a second interactive application means for collecting job applicant resume data as a document and storing the job applicant data in a second interview match applicant database from the applicant node in the memory server; each of the plurality of applicant data being respectively associated with one of the plurality of distinct applicant;
a first interface application means for automatically cross referencing the plurality of data in second interview match applicant database to plurality of data in first interview match recruiters database, to identify and determine the plurality of applicants who applied for the hiring needs of a recruiters, including a plurality of recruiters, each having a specific hiring needs;
a first listing application means coupled to first interactive application means, second interactive application means and also first interface application means for determining the prospective applicants associated with the hiring needs,
a first offer application means coupled to first listing application means for offering the prospective associated applicants to the identified recruiters;
an application means for enabling video interviewing initiated by the identified recruiter, with any one, some or all of offered prospective applicants to the identified recruiter;
an application means for the recruiter to enable invoking a process for accepting none, one, some or all of the interviewed applicants; and
an application means for the recruiter to enable invoking a process for request closure after the interviewed applicants accept the offer of the recruiter.

4. A system for interactive interview by identifying and determining the plurality of applicants who satisfy the hiring needs of a recruiter seeking resume of applicants for an interview with a service provider node for accessing web;
(ii) an internet site that allows transmitting and receiving documents using a server and a memory;
(iii) a common link between the node and the internet, comprising of:—
a first interactive application means for collecting recruiters hiring needs data as a document and storing the hiring needs data in a first interview match database in the memory; each of the plurality of hiring need data being respectively associated with one of the plurality of distinct recruiter;
a third interactive application means for collecting job applicant resume data as a document and storing the job applicant data in a third automatch applicant database from the applicant node in the memory server; each of the plurality of applicant data being respectively associated with one of the plurality of distinct applicant;
a second interface application means for automatically cross referencing the plurality of data in third automatch applicant database to plurality of data in first interview match recruiters database, to identify and determine the plurality of applicants who satisfy the hiring needs of a recruiters, including a plurality of recruiters, each having a specific hiring needs;
a second listing application means coupled to first interactive application means, third interactive application means and also second interface application means for determining which of the identified recruiters should be offered with prospective applicants associated with the hiring needs,
a second offer application means coupled to second listing application means for offering the prospective applicants to the identified recruiters;
an application means for enabling video interviewing initiated by the identified recruiter, with any one, some or all of offered prospective applicants to the identified recruiter;
an application means for the recruiter to enable invoking a process for accepting none, one, some or all of the interviewed applicants; and
an application means for the recruiter to enable invoking a process for request closure after the interviewed applicants accept the offer of the recruiter.

5. A system as claimed in claim 1-4, wherein some of the recruiters is associated with more than one hiring need type.

6. A system as claimed in claim 1-4, wherein some of the applicant is associated with more than one resume type.

7. A system as claimed in claim 1-4, wherein at least some of the distinct recruiters hiring needs compete for common applicant.

8. A system as claimed in claim 1-4, wherein at least some of the distinct applicants resume compete for common recruiter.

9. A system as claimed in claim 1-4, wherein at least some of the identified recruiters may be offered common prospective applicants, when it is determined that an identified applicant meets the hiring needs of more than one recruiter.

10. A system as claimed in claim 1-4, wherein the documents relate to resume of potential job applicants.

11. A system as claimed in claim 1-4, wherein the documents relate to resume of potential job applicants and selected recruiters.

12. A system as claimed in claim 1-4, wherein the documents relate to hiring needs of potential recruiters.

13. A system as claimed in claim 1-4, wherein the inputting means enables the applicant to submit text data in prescribed form.

14. A system as claimed in claim 1-4, wherein the inputting means enables the applicant to submit digital data in the form of audio stream.

15. A system as claimed in claim 1-4, wherein the inputting means enables the applicant to submit digital data in the form of video stream.

16. A system as claimed in claim 1-4, wherein the cross referencing step includes modifying data of the applicant database and recruiter database into corresponding target data and creating corresponding structured applicant database and structured recruiter database for storing the target data, for the purpose of comparing and matching.
